(19) United States
(12) Patent Application Publication
(10) Pub. No.: US 2018/0022217 A1
(43) Pub. Date: Jan. 25, 2018

(54) METHOD FOR DRIVING AN OPERATING ARRANGEMENT FOR A MOTOR VEHICLE WITH PROVISION OF TWO OPERATING MODES FOR AN OPERATING ELEMENT, OPERATING ARRANGEMENT AND MOTOR VEHICLE

(71) Applicant: VALEO Schalter und Sensoren GmbH, Bietigheim-Bissingen (DE)

(72) Inventors: Sascha Staude, Bietigheim-Bissingen (DE); Frank Kaiser, Bietigheim-Bissingen (DE)

(73) Assignee: VALEO Schalter und Sensoren GmbH, Bietigheim-Bissingen (DE)

(21) Appl. No.: 15/536,513

(22) PCT Filed: Dec. 14, 2015
(86) PCT No.: PCT/EP2015/079559

§ 371 Date: Jun. 15, 2017

(30) Foreign Application Priority Data
Dec. 18, 2014 (DE) 10 2014 118 956.6

(51) Int. Cl. B60K 37/06; G06F 3/0488; B60K 35/00

(52) U.S. Cl. CPC B60K 37/06; B60K 35/00; G06F 3/04883; B60K 2350/1024; B60K 2350/1052; B60K 2350/928; B62D 1/046

(57) ABSTRACT

The invention relates to a method for driving an operating arrangement (2) for a motor vehicle (1), in which, by means of an operating element (4, 4′) which is arranged on a steering wheel (5) of the motor vehicle (1) and which has a touch-sensitive screen, a touch of at least one finger (9) on the operating element (4, 4′) is registered as an operating action and, by means of a control device (3), a unit (8) is activated on the basis of the operating action registered, in a first operating mode of the operating element (4, 4′), a pointer (11) displayed on a display device (10) of the unit (8) being controlled by means of the control device (3) and, in a second operating mode of the operating element (4, 4′) at least one switching area (15) being displayed on the operating element (4, 4′), and the touch on the switching area (15) being registered as the operating action.

The present invention relates to a method for driving an operating arrangement for a motor vehicle, in which, by means of an operating element which is arranged on a steering wheel of the motor vehicle and which has a touch-sensitive screen, a touch of at least one finger on the operating element is registered as an operating action and, by means of a control device, a unit is activated on the basis of the operating action registered. The invention also relates to an operating arrangement for a motor vehicle. Finally, the invention relates to a motor vehicle having such an operating arrangement.

Interest in the present case is focused in particular on operating arrangements for motor vehicles. Such operating arrangements can, for example, comprise operating elements with which an operating action can be registered. These operating elements can, for example, be arranged on the steering wheel of the motor vehicle. As a result of the operating action registered, a functional device of the motor vehicle can be activated or operated by using a control device. By using such operating elements, for example, an information and/or entertainment system, a communications device, a driver assistance system or the like can be operated.

The prior art discloses operating elements which are arranged on the steering wheel of the motor vehicle and which, for example, are formed as so-called steering wheel switches. These steering wheel switches comprise a mechanical switch, for example, in particular a microswitch, over which a rubber mat or another covering is arranged. Also disclosed are operating elements for steering wheels which comprise touch-sensitive sensors. Sensors of this type can be formed, for example, as capacitive or resistive sensors. Each switch or each sensor serves only to operate a single vehicle function or a single functional device of the motor vehicle. Because of the rising number of vehicle functions, the number of operating elements on and/or in the steering wheel is also increasing. This has the consequence that the driver can lose the clear overview in the operation of the operating elements. This is in turn associated with increased distraction during the operation of the motor vehicle and thus an increased risk of accident. A further disadvantage of such operating arrangements is the restricted ability to be personalised and the inability to change the functions.

In order to reduce the distraction of an operator of a motor vehicle, U.S. Pat. No. 7,295,904 B2 proposes an apparatus for driving units and systems in a motor vehicle. The apparatus has one or more touch-sensitive surfaces, which are applied to the steering wheel of the motor vehicle. The operator can touch these surfaces by using predefined patterns, in order to carry out functions such as the control of a radio or the adjustment of a window. Here, at least some of the predefined patterns can be predefined by the operator.

Furthermore, DE 10 2010 012 240 A1 discloses an operating and display apparatus of a motor vehicle. The operating and display apparatus comprises at least two operating devices, it being possible for the operating device to respectively be assigned a group of functions that can be selected and chosen. In addition, the functional groups can be displayed on a display device. Here, provision is made for a common display area to be provided on the display device for the display of the functional groups and, in the event of the operating means approaching one of the operating devices and/or in the event of touching one of the same, substantially only the functions that can respectively be selected and chosen by the respective operating device are displayed in the common display areas.

Furthermore, DE 20 2006 008 254 U1 describes a vehicle cockpit having a vehicle steering wheel which has a steering wheel outer surface that is accessible to a user, the steering wheel being formed in such a way that, via the latter, finger movements on the steering wheel outer surface can be registered. Also provided is an evaluation circuit for generating evaluation signals, which as such are associated with the finger movement and the position of the finger on the steering wheel.

It is an object of the present invention to indicate a solution as to how, in an operating arrangement of the type mentioned at the beginning, the functional scope can be expanded and in addition more secure operation can be made possible.

According to the invention, this object is achieved by a method, by an operating arrangement and by a motor vehicle having the features according to the respective independent patent claims. Advantageous embodiments of the invention are the subject matter of the dependent patent claims, the description and the figures.

A method according to the invention is used to drive an operating arrangement for a motor vehicle. Here, by means of an operating element which is arranged on the steering wheel of the motor vehicle and which has a touch-sensitive screen, a touch of at least one finger on the operating element is registered as an operating action. Furthermore, by means of the control device, a unit is activated on the basis of the operating action registered. In addition, in a first operating mode of the operating element, a pointer displayed on a display device of the unit is controlled by means of the control device. In a second operating mode of the operating element, at least one switching area is displayed on the operating element, and the touch on the switching area is registered as the operating action.

The method is used to drive an operating arrangement which can be used in a motor vehicle. An operating element is provided which is arranged on the steering wheel of the motor vehicle. Such a steering wheel is used in particular for driving the steerable wheels of the motor vehicle. The steering wheel usually has a steering wheel rim and multiple spokes, via which the steering wheel rim is held on a central part of the steering wheel. The operating element can be arranged on the steering wheel rim. In particular, the operating element is arranged on a spoke of the steering wheel. Provision can also be made for the operating arrangement to have multiple operating elements. The operating element has a touch-sensitive screen. In other words, the operating element has a so-called touch screen. The operating element is designed to register an operating action which is carried out on the operating element by using at least one finger of a vehicle occupant, in particular the driver. Such an operating action can be, for example, touching the surface of the touch-sensitive screen. Such an operating action can also be a wiping gesture which is carried out on the surface.

Also provided is a control device, which is connected to the operating element for data transmission. The control device can be provided, for example, by a control unit of the motor vehicle. If an operating action is registered by the operating element, an appropriate signal can be transmitted from the operating element to the control device. By using the control device, a unit can then be activated on the basis of the operating action registered.

The operating element and/or the operating arrangement can now be operated in a first and in a second operating mode. In the first operating mode, on the basis of the operating action, a pointer which is displayed on a display device of the unit is controlled. In other words, in the first operating mode the operating element serves as a touchpad, it being possible for a pointer on a display device to be controlled as a result of the operating action carried out on the operating element. Such a pointer, which is displayed on the display device, can also be designated as a cursor. In a second operating mode, at least one switching area is displayed on the operating element. In particular, multiple switching areas are displayed on the operating element. These switching areas can be selected and driven by an operating action, in particular by a touch. These switching areas can be assigned to corresponding functions of the unit. Thus, as a result of the operation of the switching area, the corresponding function of the unit can be activated. By means of the two operating modes, the operating arrangement can be driven on the basis of a situation or state. Thus, the functional scope of the operating arrangement is expanded.

Preferably, in the first operating mode the position of the at least one finger on the operating element is registered and, by using the position registered, a pointer position of the pointer on the display device is determined. The operating element is designed to register the position of the at least one finger on the operating element or on a surface of the operating element. With the aid of the control device, depending on the position determined, a pointer position which corresponds to the position of the pointer on the display device can be determined. The operating element can also be designed to register movement of the at least one finger on the operating element, and the control device can then move the pointer on the display device in accordance with the movement of the finger. Thus, an operation such as is known, for example, from a touchpad of a computer is made possible. The display device can, for example, be arranged within the motor vehicle. It can be arranged, for example, in the combination instrument, in the central console and/or in the dashboard. The display device can also be a so-called head-up display. Thus, with the aid of the operating element in the first operating mode, a pointer on a display device of the motor vehicle is controlled.

In a further embodiment, in the first operating mode, by using the pointer, a display element on the display device is selected and the unit is activated on the basis of the selected display element. One or more display elements which are linked with respective functions of the unit can be displayed on the display device. If the unit is an information and/or entertainment system, the display elements can be assigned, for example, to music titles or albums which can be selected appropriately with the pointer and then played back. To select the display elements, the pointer can be moved on the display element by means of a corresponding operating input on the operating element. The selection can then be confirmed, for example by means of a corresponding operating action. For this purpose, a pressure movement can be exerted on the operating element. Thus, with the aid of the operating element, functions of the unit can be selected in a simple way in the first operating mode.

In a further refinement, in the first operating mode the operating element is activated in such a way that the touch-sensitive screen has a predetermined colour. The operating element can be activated in such a way that the complete touch-sensitive screen has the same colour. For example, the operating element or the touch-sensitive screen can be completely grey or black. For this purpose, for example the display on the touch-sensitive screen can be deactivated. Thus, the touch-sensitive screen can be used merely as an input unit or as a touchpad.

In a further embodiment, in the second operating mode of the operating element the unit is activated by touching the switching area. It is possible for one or more switching areas, which are assigned to respective functions of the unit, to be arranged on the operating element. The switching areas can display appropriate symbols which are linked with functions of the unit. By touching the switching areas on the operating element, the corresponding function of the unit can be activated in a simple way.

Furthermore, it is advantageous if, in the second operating mode of the operating element, a depiction of a switching element of the unit is displayed on the operating element as a unit switching area, and the unit is activated as a result of touching the unit switching area. If the unit, in addition to the display device, has switching elements with which the unit can be operated directly by a touch on the switching areas, these switching areas can be displayed on the operating element as unit switching areas. Thus, both the switching areas and also the unit switching areas can be displayed on the operating element.

Preferably, the function assigned to the switching element is effected by the activation of the unit. The data link between the operating element and the unit can be equipped in such a way that the operation or touching of the unit switching areas effects the function which direct operation or touching of the unit switching areas would effect. It is therefore possible for a so-called mirror link function to be provided. This is suitable in particular if the unit is a mobile unit, such as a mobile telephone or a portable computer, for example. Thus, the driver can operate the functions of the unit, starting from the steering wheel. The driver can, so to speak, remotely control the unit, starting from the steering wheel. Thus, in order to operate the unit, the driver does not have to take his/her hands off the steering wheel, which increases traffic safety.

In a further embodiment, the operating element has a static area and a dynamic area, the operating action being registered in the dynamic area. In other words, the operating element has two areas separated physically from each other. Here, the display in the dynamic area of the operating element is changed. In the static area of the operating element, switching areas with which basic functions can be provided can likewise be displayed. Such basic functions can be, for example, the setting of the loudness, activation of a voice input or the like. Thus, simple operation can be made possible.

In a preferred embodiment, the operating arrangement has a first and a second operating element, the first operating element being driven in the first operating mode and the second operating element being driven in the second operating mode. It is thus possible for two operating elements to be arranged on the steering wheel, each having a touch-sensitive screen. For example, the first operating element can be arranged on a first side and the second operating element on a second side of the steering wheel. The first operating element is driven in the first operating mode. The first operating element is therefore used as a touchpad in order to control a pointer or cursor on the display device. The second operating element is used to activate the switching areas displayed on the operating element. It is also possible to provide for the respective operating modes of the two operating elements to be adapted, depending on the situation.

In a further refinement, the unit, which is formed as a mobile telephone, is activated by means of the control device. The unit can be a mobile telephone which, in particular, is formed as a smart phone. The unit can also be formed as a portable computer, in particular as a laptop. Furthermore, the unit can be formed as a so-called tablet. It is also possible for a data link to be set up between the operating arrangement and multiple units. Such a data link can be made, for example, via a data cable or in a wire-free manner. Furthermore, provision can be made by means of a predetermined operating action, for example a wiping gesture, for it to be possible to change between the various units which can be activated or remotely controlled by the operating element in the second operating mode. Thus, simple operation of multiple mobile units which are arranged in the motor vehicle can be made possible. This is suitable in particular, for example, when the motor vehicle is being operated in an autonomous operating mode.

An operating arrangement according to the invention for a motor vehicle comprises an operating element which has a touch-sensitive screen and which is arranged on the steering wheel of the motor vehicle. The operating element is thus designed to register a touch on the operating element as an operating action. Furthermore, the operating arrangement has a control device, which is designed to activate a unit on the basis of the operating action registered. In addition, in a first operating mode, the operating element is designed to control a pointer displayed on the display device on the basis of the operating action registered and, in a second operating mode, to display at least one switching area on the operating element and to register the touch on the at least one switching area as the operating action. An operating arrangement according to the invention is designed to carry out a method according to the invention.

A motor vehicle according to the invention comprises an operating arrangement according to the invention. The motor vehicle is formed in particular as a passenger car.

The preferred embodiments put forward with reference to the method according to the invention, and the advantages thereof, apply in a corresponding way to the operating arrangement according to the invention and to the motor vehicle according to the invention.

Further features of the invention can be gathered from the claims, the figures and the figure description. The features and feature combinations named in the description, and the features and feature combinations named below in the figure description and/or shown on their own in the figures can be used not only in the respectively indicated combinations but also in other combinations or on their own without departing from the scope of the invention. Thus, embodiments of the invention which are not shown and explained explicitly in the figures but which arise and can be produced from the embodiments explained by means of separate feature combinations are also to be viewed as covered and disclosed. Embodiments and feature combinations which thus do not have all the features of an originally formulated independent claim are also to be viewed as disclosed.

The invention will now be explained in more detail by using preferred exemplary embodiments and with reference to the appended drawings, in which:

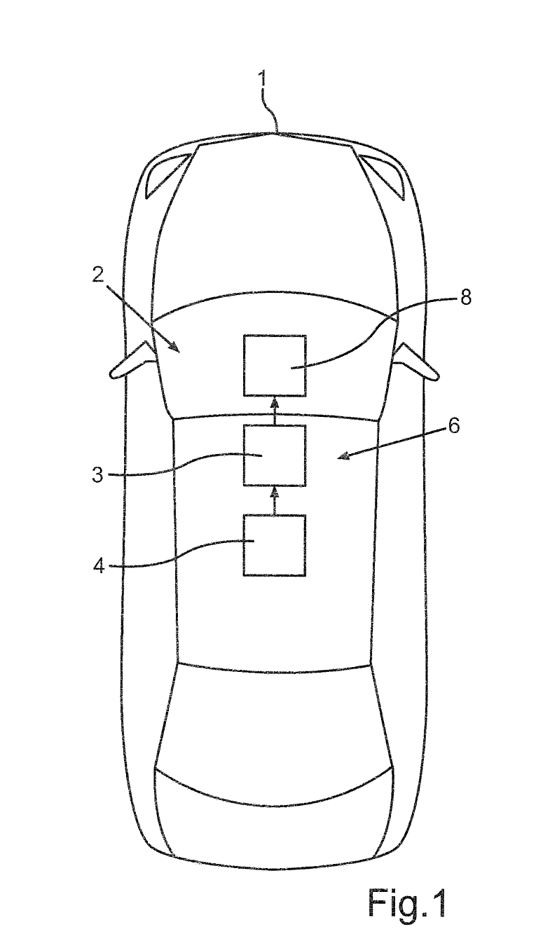

FIG. 1 shows, in a schematic illustration, a motor vehicle according to an embodiment of the present invention which has an operating arrangement;

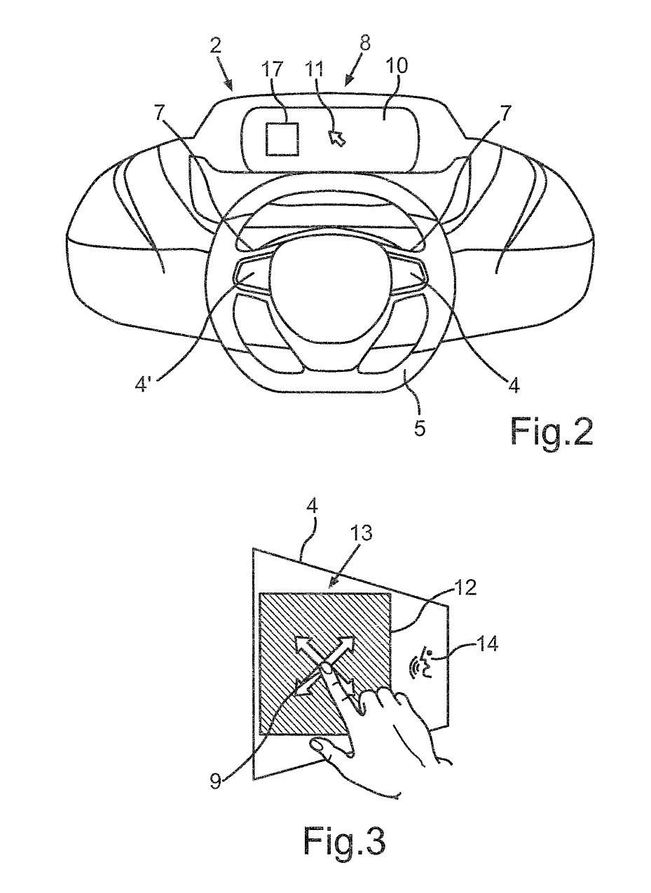

FIG. 2 shows the operating arrangement in a further embodiment, the operating arrangement having two operating elements which are arranged on a steering wheel;

FIG. 3 shows a first operating element of the operating arrangement;

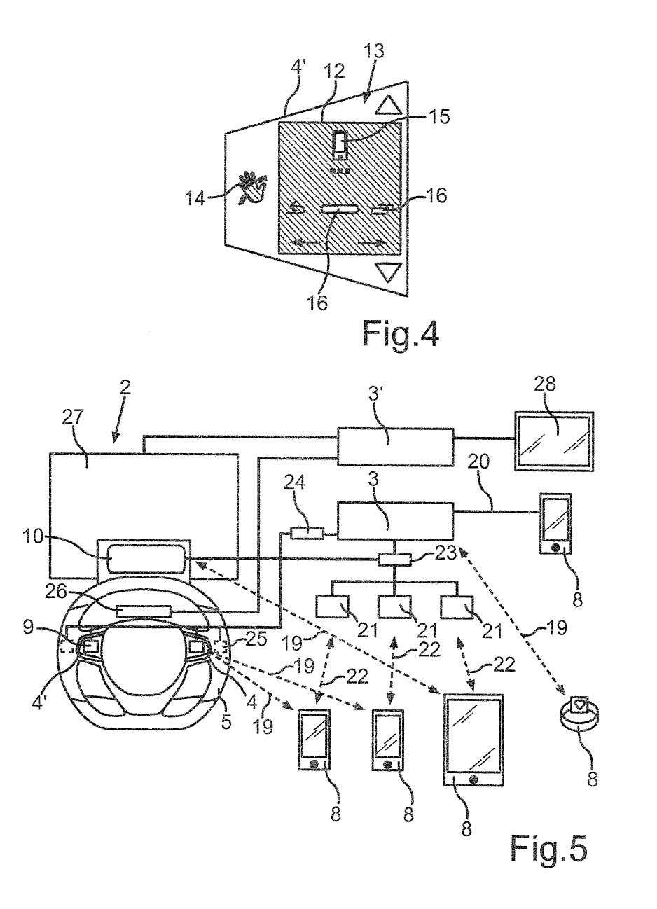

FIG. 4 shows a second operating element of the operating arrangement; and

FIG. 5 shows the operating arrangement in a first embodiment, the operating arrangement being connected to a plurality of mobile units.

In the figures, identical and functionally identical elements are provided with the same reference symbols.

FIG. 1 shows a motor vehicle 1 according to one embodiment of the present invention in plan view. In the present case, the motor vehicle 1 is formed as a passenger car. The motor vehicle 1 comprises an operating arrangement 2 which, for example, can be part of a driver assistance system of the motor vehicle 1. The driver assistance system can be used, for example, to assist the driver when guiding the motor vehicle 1. With the aid of the driver assistance system, the motor vehicle 1 can, for example, be manoeuvred autonomously. In this case, the driver assistance system takes over the transverse guidance and/or longitudinal guidance of the motor vehicle 1. The driver assistance system can therefore carry out a steering intervention, an intervention in the braking system and/or an intervention in the drive engine of the motor vehicle 1. However, the motor vehicle 1 can also be operated manually. In this operating mode, the driver takes over both the longitudinal guidance and also the transverse guidance of the motor vehicle 1.

The operating arrangement 2 comprises a control device 3, which can be formed, for example, by a control unit of the motor vehicle (ECU—Electronic Control Unit). In addition, the operating arrangement 2 comprises at least one operating element 4, with which an operating action can be registered. The operating element 4 has a touch-sensitive screen. A display can therefore be provided by using the operating element 4. In addition, the operating element 4 has appropriate sensors, with which a touch on the touch-sensitive screen can be registered. Such a touch can be made, for example, by at least one finger 9 of an occupant of the motor vehicle 1, in particular the driver of the motor vehicle 1. Furthermore, the operating arrangement 2 has a unit 8 which, in the present case, is arranged in an interior 6 of the motor vehicle 1. If an operating action is registered by the operating element 4, a corresponding signal is transmitted from the operating element 4 to the control device 3. The control device 3 can then generate a control signal on the basis of the operating action registered and transmit the said signal to the unit 8. Thus, a function of the unit 8 can be activated.

FIG. 2 shows the operating arrangement 2 in a further embodiment. In this embodiment, the operating arrangement 2 has a first operating element 4 and a second operating element 4′. The first and the second operating element 4, 4′ are arranged on the spokes 7 of the steering wheel. It can also be seen that the unit 8 has a display device 10. The display device 10, which, for example, can be a monitor or a display, is arranged in the instrument cluster of the motor vehicle 1 in the present case. A pointer 11 or a cursor is displayed on the display device 10. Also displayed on the display device 10 is a display element 17. The display element 17 can be selected with the pointer 11. By means of the selection of the display element 17, a function of the unit 8 can be activated.

In the exemplary embodiment according to FIG. 2, the unit 8 is part of the motor vehicle 1. The unit 8 can be, for example, an information and/or entertainment system of the motor vehicle 1. In this case, the display element 17 can be assigned to a music title or an album. If the display element 17 is selected by using the pointer 11, for example the music title can be played back. The unit 8 can also be a navigation system, a driver assistance system, an air-conditioning system or the like. Provision can also be made for the unit 8 to be a mobile unit, which can be arranged in the interior 6 of the motor vehicle 1. Such a mobile unit 8 can be, for example, a smart phone, a tablet or the like.

FIG. 3 shows the first operating element 4, which, in the present case, is arranged on the right-hand side of the steering wheel 5. It can be seen here that the first operating element 4 has two areas, specifically a dynamic area 12 and a static area 13. In the dynamic area 12, the display of the touch-sensitive screen can be adapted. In the static area 13, corresponding switching areas 14 with which basic functions can be provided can be displayed. In the present case, a voice input can be enabled by touching the switching area 14. In the dynamic area 12, the position of the finger 11 can be detected. By using the position, the control device 3 can then determine a position of the pointer 11 which is displayed on the display device 10. The finger 9 can be moved appropriately in the dynamic area 12 of the operating element 4 in order to move the pointer 11 on the display device 10. Thus, the operating element 4 serves as a touchpad in the first operating mode.

FIG. 4 shows a second operating element 4′ which, in the present case, is arranged on the left-hand side of the steering wheel 5. The second operating element 4′ also has a static area 13 and a dynamic area 12. In the present case, switching areas 14, with which for example the loudness can be controlled, are likewise displayed in the static area 13. Likewise displayed is a switching area 14, with which autonomous driving operation can be requested. As explained in more detail below, a data link can be provided between the second operating element 4′ and a mobile unit 8. Here, data links can also be provided between multiple mobile units 8. These mobile units 8 can be activated and remotely controlled with the aid of an operating action which is carried out on the second operating element 4′. In the dynamic area 12, the driver is displayed a switching area 15, which he can operate appropriately by means of touch. In the present case, the switching area shows a mobile unit 8 or mobile telephone, which can be activated appropriately. In addition, unit switching areas 16 are displayed in the dynamic area 12. These unit switching areas 16 display the image of switching elements of the mobile unit 8. These unit switching areas 16 can be operated by means of an appropriate operating action, in particular a touch. If the unit switching area 16 is operated, the mobile unit 8 can be driven in the same way as when the unit 8 is operated directly. Thus, the mobile unit 8 can, so to speak, be remotely controlled.

FIG. 5 shows, by way of example, how the operating arrangement 2 can be coupled to multiple mobile units 8 in the motor vehicle 1. In the present exemplary embodiment, the operating arrangement 2 can be connected to multiple mobile units 8 by means of data transmission. The mobile units 8 can be, for example, mobile telephones, smart phones, tablets, smart watches or sport armbands. The mobile terminals can be connected to the operating elements 4, 4′ for data transmission, for example via a radio connection, in particular a Bluetooth connection. The mobile units 8 can also be connected to the control device 3 or the display device 10 via a Bluetooth connection. Such a wire-free connection is identified by the arrows 19. Furthermore, provision can be made for the mobile units 8 to be connected to the control device 3 via a data bus 20. It is also possible for various communications devices 21 to be provided, via which the mobile units 8 can communicate in a wire-free manner with the control device 3. Such a wire-free data link can be, for example, a radio link, which is identified by the arrows 22. By means of an appropriate interface 23, the display of the mobile units 8 can thus be transmitted to the display device 10. Furthermore, with the aid of the control device 3, the display in the dynamic area 12 of the operating element 4, 4′ can be adapted via an appropriate interface 24.

With the aid of sensor elements 25, it is additionally possible to check whether the hands of the driver are currently located on the steering wheel 5. The sensor elements 25 can comprise capacitive sensors, for example. This information can be transmitted from the sensor elements 25 to the control device 3 via the interface 24. Furthermore, the operating arrangement 2 can comprise a detection unit 26, by means of which the direction of view of the driver and/or the position of a head of the driver can be detected. Depending on this information, the display on further display devices 27, 28 can be controlled by a second control device 3′. The display device 27 can be assigned, for example, to a so-called head-up display. The display device 28 can, for example, be in the dashboard of the motor vehicle 1.

1. A method for driving an operating arrangement for a motor vehicle, the method comprising:
registering, by an operating element arranged on a steering wheel of the motor vehicle and which has a touch-sensitive screen, a touch of at least one finger on the operating element as an operating action; and,
activating, by a control device, a unit on the basis of the operating action registered,
wherein, in a first operating mode of the operating element, a pointer displayed on a display device of the unit is controlled by the control device, and
wherein, in a second operating mode of the operating element, at least one switching area is displayed on the operating element, and the touch on the at least one switching area is registered as the operating action.

2. The method according to claim 1, wherein in the first operating mode the position of the at least one finger on the operating element is registered and, by using the position registered, a pointer position of the pointer on the display device is determined.

3. The method according to claim 1, wherein in the first operating mode, by using the pointer, a display element on the display device is selected and the unit is activated on the basis of the selected display element.

4. The method according to claim 1, wherein in the first operating mode the operating element is activated in such a way that the touch-sensitive screen has a predetermined colour.

5. The method according to claim 1, wherein in the second operating mode of the operating element the unit is activated by touching the switching area.

6. The method according to claim 1, wherein in the second operating mode of the operating element, a depiction of a switching element of the unit is displayed on the operating element as a unit switching area, and the unit is activated as a result of touching the unit switching area.

7. The method according to claim 6, wherein the function assigned to the switching element is effected by touching the unit switching area.

8. The method according to claim 1, wherein the operating element has a static area and a dynamic area, the operating action being registered in the dynamic area.

9. The method according to claim 1, wherein the operating arrangement has a first and a second operating element, the first operating element being driven in the first operating mode and the second operating element being driven in the second operating mode.

10. The method according to claim 1, wherein the unit, which is formed as a mobile telephone, is activated by means of the control device.

11. An operating arrangement for a motor vehicle for carrying out a method according to claim 1.

12. A motor vehicle having an operating arrangement according to claim 11.
